(19) United States
(12) Patent Application Publication
(10) Pub. No.: US 2012/0293531 A1
(43) Pub. Date: Nov. 22, 2012

(54) IMAGE PROCESSING METHOD AND PIXEL ARRAY OF FLAT DISPLAY PANEL

(76) Inventors: Wen-Chun Wang, Taichung City (TW); Ching-Fu Hsu, Taichung City (TW); Chen-Ho Hsu, Kaohsiung City (TW)

(21) Appl. No.: 13/472,492

(22) Filed: May 16, 2012

(30) Foreign Application Priority Data
May 18, 2011 (TW) 100117412

(51) Int. Cl. G09G 5/02

(52) U.S. Cl. 345/589

(57) ABSTRACT

An image processing method of a flat display panel includes the following steps. A pixel array including a plurality of display units is provided, and each display unit includes two sub-pixels. An image-signal-to-be-processed is provided. The image-signal-to-be-processed includes a plurality of pixel data, and each of the pixel data includes three primary color data of three different primary colors. A display signal generating process is performed to write two primary color data selected from at least one pixel data of the image-signal-to-be-processed to two sub-pixels of the display unit of the pixel array.

### BACKGROUND OF THE INVENTION

1. Field of the Invention

The present invention relates to an image processing method of a flat display panel and a pixel array of the same, and particularly to an image processing method of a flat display panel of high resolution without color mixing problems and a pixel array of the same.

2. Description of the Prior Art

With the growing display technology, many types of flat display, such as low-temperature polycrystalline silicon thin-film transistor liquid crystal display (LTPS-TFT LCD), amorphous silicon thin-film transistor liquid crystal display (a-Si TFT LCD), organic electroluminescent display (EL display) such as organic light emitting diode display (OLED display), have been developed. Among theses, OLED display is getting important due to it advantages of low-voltage, rapid response, high brightness, vivid color, wide view angle, flexibility and so on.

Please refer to FIG. 1. FIG. 1 is a schematic diagram showing a pixel array of a conventional OLED display. As shown in FIG. 1, a pixel array 30 of a conventional OLED display includes a red sub-pixel R, a green sub-pixel G and a blue sub-pixel B arranged in stripe. The adjacent red sub-pixel R, green sub-pixel G and blue sub-pixel B in a same row will constitute a pixel P. The pixel array 30 of the conventional OLED display are made through three vapor deposition processes to form the red sub-pixel R, green sub-pixel G and blue sub-pixel B, respectively, on a substrate. With more and more demands for high resolution products, the pitch distance between the red sub-pixel R, green sub-pixel G and blue sub-pixel B is decreasing. However, since there is a limit for the shadow mask used in the current vapor deposition process, color mixing problems easily occur for a requirement of the design of high resolution, and thereby the development of OLED display is impeded.

### SUMMARY OF THE INVENTION

One of the objectives of the present invention is to provide an image processing method of a flat display panel and a pixel array of the same to resolve the color mixing problems of high resolution display panel.

A preferred embodiment of the present invention provides an image processing method of a flat display panel which includes steps as follows. A pixel array is provided. The pixel array includes a plurality of display units. Each display unit includes two sub-pixels. An image-signal-to-be-processed is provided. The image-signal-to-be-processed includes a plurality of pixel data. Each of the pixel data includes three different primary color data. A display signal generating process is performed to write two primary color data of at least one of the pixel data of the image-signal-to-be-processed to the two sub-pixels of the display unit of the pixel array.

Another preferred embodiment of the present invention provides a pixel array of a flat display panel including a plurality of display units arranged in an array. Each display unit includes two sub-pixels. Any three adjacent sub-pixels in a row of the array are for displaying three different primary colors, respectively.

In the image processing method according to the present invention, two primary color data are selected from three different primary color data of the image-signal-to-be-processed and written to two sub-pixels of a corresponding display unit of the pixel array for serving as actual output display signals. Accordingly, image signal of relatively high resolution can be rendered to a pixel array of relatively low resolution and color mixing problems can be prevented.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a pixel array of a conventional OLED display;

FIG. 2 is a flowchart illustrating an image processing method of a flat display panel according to the present invention;

FIG. 3 and FIG. 4 are schematic diagrams illustrating an image processing method of a flat display panel according to the first preferred embodiment of the present invention;

FIG. 5 is a schematic diagram illustrating an image processing method of a flat display panel according to the second preferred embodiment of the present invention;

FIG. 6 is a schematic diagram illustrating an image processing method of a flat display panel according to the third preferred embodiment of the present invention; and

FIG. 7 and FIG. 8 are schematic diagrams illustrating an image processing method of a flat display panel according to the fourth preferred embodiment of the present invention.

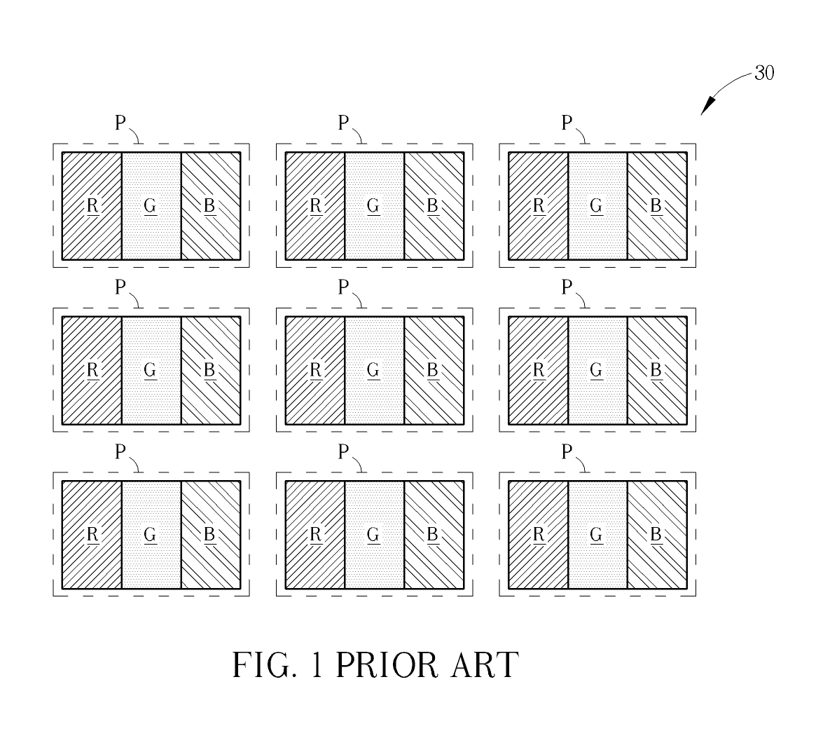

### DETAILED DESCRIPTION

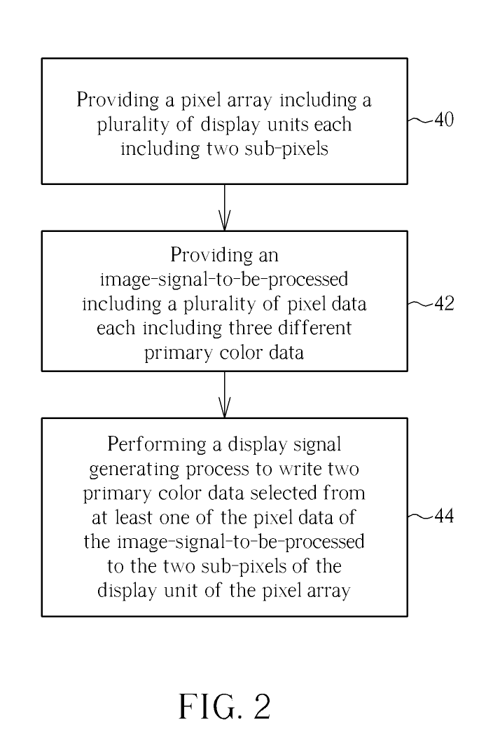

Please refer to FIG. 2. FIG. 2 is a flow chart illustrating an image processing method of a flat display panel according to the present invention. As shown in FIG. 2, the image processing method of a flat display panel according to the present invention includes steps as follows:

Step 40: providing a pixel array including a plurality of display units each including two sub-pixels;

Step 42: providing an image-signal-to-be-processed including a plurality of pixel data each including three different primary color data; and

Step 44: performing a display signal generating process to write two primary color data selected from at least one of the pixel data of the image-signal-to-be-processed to the two sub-pixels of the display unit of the pixel array.

In view of the aforesaid, in the image processing method of a flat display panel according to the present invention, the primary color data (such as RGB data signal) to represent three different primary colors are simplified into two primary color data, and each display unit of the pixel array has only two sub-pixels. Accordingly, the image signal of relatively high resolution can be processed utilizing the pixel array of relatively low resolution, and the color mixing problems caused by the small pitch distance between different color sub-pixels of the pixel array of the flat display panel of high resolution can be prevented. It is worth to note that the image processing method according to the present invention can be applied to organic EL display panels such as OLED display panels, as well as other types of flat display panels such as liquid crystal display panels, plasma display panels, field-emitting display panels, electrophoretic display panels and the like, but not limited thereto.

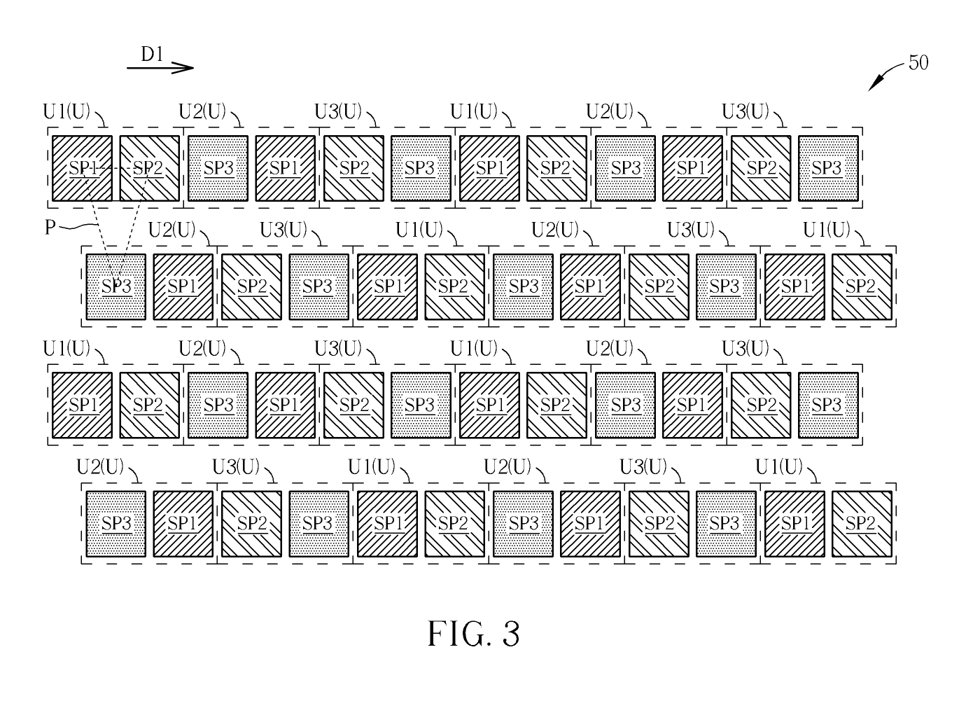

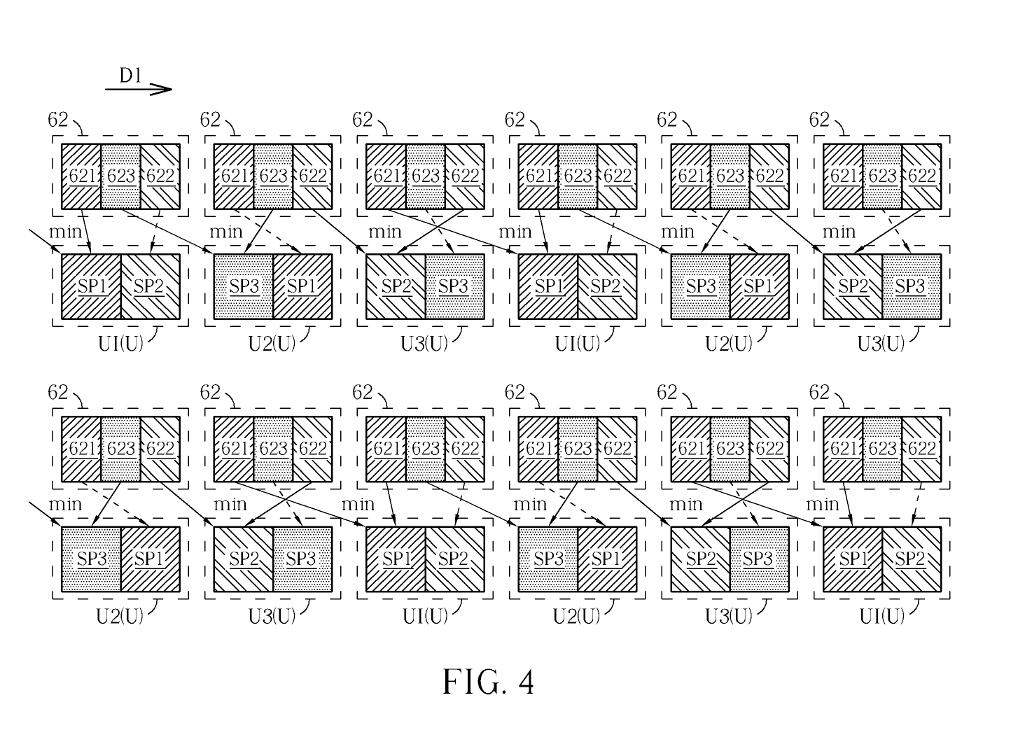

Please refer to FIG. 3 and FIG. 4 with FIG. 2 together. FIG. 3 and FIG. 4 are schematic diagrams illustrating an image processing method of a flat display panel according to the first preferred embodiment of the present invention. As shown in FIG. 3, first, a pixel array 50 of a flat display panel is provided. The pixel array 50 includes a plurality of display units U. The display units U may be further categorized into a plurality of first display units U1, second display units U2 and third display units U3. The first display units U1, the second display units U2 and the third display units U3 are substantially arranged alternately in the array. In addition, each display unit U includes two sub-pixels, and each display unit U preferably consists of two sub-pixels. For example, each first display unit U1 consists of a first sub-pixel SP1 for displaying the first primary color and a second sub-pixel SP2 for displaying the second primary color, each second display unit U2 consists of a first sub-pixel SP1 for displaying the first primary color and a third sub-pixel SP3 for displaying the third primary color, and each third display unit U1 consists of a second sub-pixel SP2 for displaying the second primary color and a third sub-pixel SP3 for displaying the third primary color. In addition, any three adjacent sub-pixels, such as the first sub-pixel SP1, the second sub-pixel SP2 and the third sub-pixel SP3, in one row of the array are three sub-pixels for displaying three different primary colors, respectively. Furthermore, in this embodiment, the sub-pixels located in the same row of the array are shifted a distance less than the width of the sub-pixel with respect to the sub-pixels in the adjacent row in the first direction D1. Such type of pixel arrangement is also referred to as “delta arrangement”. Accordingly, a pixel P is in a shape of isosceles triangle formed by the first sub-pixel SP1, the second sub-pixel SP2 and the third sub-pixel SP3, which are adjacent to each other, as shown in FIG. 3. In the present invention, each of the first primary color, the second primary color and the third primary color is one of the three primary colors, red, green and blue. For example, the first primary color is red, the second primary color is blue, and the third primary color is green, but it is not limited thereto. The first sub-pixel SP1, the second sub-pixel SP2 and the third sub-pixel SP3 in the present invention preferably have the same shape and area, but it is not limited thereto. In addition, in one variation of this embodiment, the sub-pixels located in different rows may all correspond with each other. Such arrangement of the pixels is also referred to as “stripe arrangement.” With such arrangement, the pixel is in a shape of right-angled triangle formed by the first sub-pixel SP1, the second sub-pixel SP2 and the third sub-pixel SP3, which are adjacent to each other.

As shown in FIG. 3 and FIG. 4, an image-signal-to-be-processed is provided. The image-signal-to-be-processed includes a plurality of pixel data 62. Each of the pixel data 62 includes three different primary color data, such as the first primary color data 621, the second primary color data 622 and the third primary color data 623. Thereafter, a display signal generating process is performed to select two primary color data from at least a pixel data 62 of the image-signal-to-be-processed and to write these two primary color data to two sub-pixels of the display unit U of the pixel array 50 for use as the display signal for the display unit U. The aforesaid two primary color data may be indicated by the arrow mark in the solid line and the arrow mark in the dashed line, respectively, for example, as shown in FIG. 4.

In the present invention, the pixel array 50 includes X*Y (which represents “X multiplied by Y”) display units U, and the image-signal-to-be-processed includes N*M (which represents “N multiplied by M”) pixel data 62, in which, X*Y is less than N*M. In other words, in the image processing method according to the present invention, pixel data 62 of relatively high resolution can be rendered to a pixel array 50 of relatively low resolution. For example, the resolutions of the pixel array 50 and the pixel data 62 may have the relation as follows: X*Y=2(N*M)/3, but be not limited thereto.

In the first embodiment, the display signal generating process includes steps as follows. One of the primary color data selected from one of the pixel data 62 of the image-signal-to-be-processed is written to one sub-pixel of a corresponding display unit U of the pixel array 50, as indicated by the arrow mark in the dashed line shown in FIG. 4. Another one of the primary color data, which is the minimum (denoted as “min”) of another primary color data of the pixel data 62 and a primary color data of another pixel data of the image-signal-to-be-processed, both of the same color, is written to the other sub-pixel of the corresponding display unit U, as indicated by the arrow mark in the solid line shown in FIG. 4. For example, with respect to each first display unit U1, the display signal generating process includes: writing the second primary color data 622 of the corresponding pixel data 62 of the image-signal-to-be-processed to the second sub-pixel SP2 of a display unit U1, and writing the minimum, min, of the first primary color data 621 of the corresponding pixel data 62 and the first primary color data 621 of another pixel data 62 to the first sub-pixel SP1 of the display unit U1. Likewise, with respect to each second display unit U2 and each third display unit U3, the data of the minimum, min, of two third primary color data 623 and the data of the first primary color data 621 are written to the third sub-pixel SP3 and the first sub-pixel SP1 of the display unit U2, respectively, and the data of the minimum, min, of two second primary color data 622 and the data of the third primary color data 623 are written to the second sub-pixel SP2 and the third sub-pixel SP3 of the display unit U3, respectively, in accordance with for example the rule illustrated in FIG. 4.

In the image processing method according to the present invention, two primary color data are selected from three primary color data of the image-signal-to-be-processed to serve as the output display signal in effect. Accordingly, image signal of relatively high resolution can be rendered to a pixel array of relatively low resolution. In this embodiment, in accordance with the selection rule for the pixel data 62, one primary color data is directly selected from the corresponding pixel data 62 and written to a corresponding sub-pixel, for example, the first primary color data 621 of the corresponding pixel data 62 is written to the first sub-pixel SP1; and the minimum, min, of two primary color data (for representing another primary color) of the corresponding pixel data 62 and another adjacent pixel data 62 is selected and written to another sub-pixel, for example, the minimum, min, of the second primary color data 622 of the corresponding pixel data 62 and the second primary color data 622 of the adjacent pixel data 62 is written to the second sub-pixel SP2.

The image processing method according to the present invention is not limited to the aforesaid embodiments. Other embodiments according to the present invention are described hereinafter. For conciseness and easy comparison among the embodiments, only the variations maybe described in detail, and the same referral numbers or symbols denote the same elements or signals.

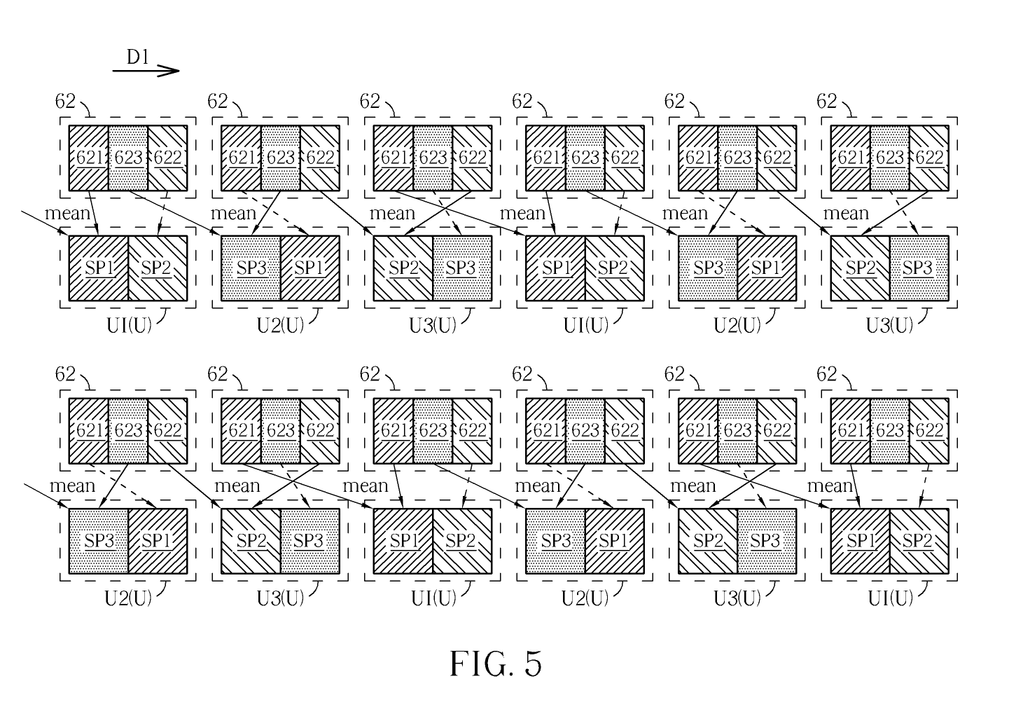

Please refer to FIG. 5 with FIG. 2 and FIG. 3 together. FIG. 5 is a schematic diagram illustrating an image processing method of a flat display panel according to the second preferred embodiment of the present invention. In this embodiment, as shown in FIG. 3 and FIG. 5, the rule for selecting the first sub-pixel displaying signal and the second sub-pixel display signal to serve as display signal is similar to that in the first preferred embodiment. The difference is that, with respect to each display unit U, in the image processing method of this embodiment, a primary color data of a pixel data 62 of the image-signal-to-be-processed is written to a sub-pixel of a corresponding display unit U of the pixel array 50, and that a mean value (denoted as “mean”) of another primary color data of the pixel data 62 and a primary color data of another pixel data of the image-signal-to-be-processed, both of the same color, is written to the other sub-pixel of the display unit.

The image processing method is performed with the concept of pixel sharing in the first and the second preferred embodiments, thereby to render an image signal of relatively high resolution to a pixel array of relatively low resolution. The color of the actual display image may be very close to the color of the unprocessed display image, and color mixing problems may be prevented.

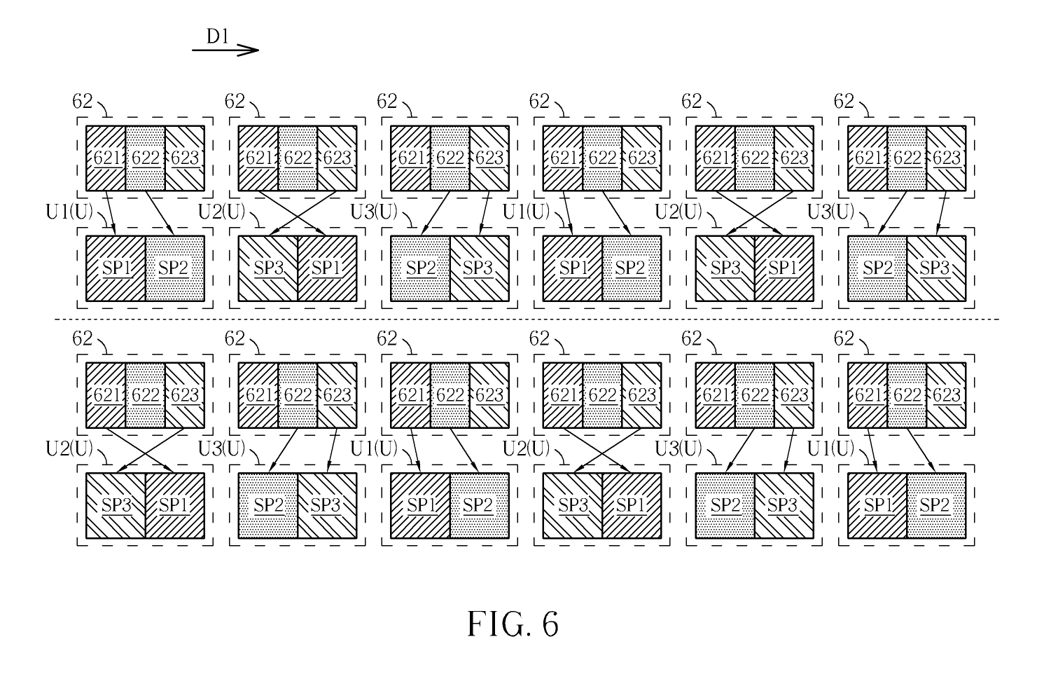

Please refer to FIG. 6 with FIG. 2 and FIG. 3 together. FIG. 6 is a schematic diagram illustrating an image processing method of a flat display panel according to the third preferred embodiment of the present invention. In this embodiment, as shown in FIG. 3 and FIG. 6, the display signal generating process includes writing two primary color data of one pixel data 62 of the image-signal-to-be-processed to two sub-pixels of a corresponding display unit U of the pixel array 50. For example, with respect to each first display unit U1, the display signal generating process includes: writing the first primary color data 621 of the corresponding pixel data 62 of the image-signal-to-be-processed to the first sub-pixel SP1 of the first display unit U1, and writing the second primary color data 622 of the corresponding pixel data 62 to the second sub-pixel SP2 of the first display unit U1. Likewise, with respect to each second display unit U2 and each third display unit U3, the third primary color data 623 and the first primary color data 621 may be written to the third sub-pixel SP3 and the first sub-pixel SP1 of the display unit U2, respectively, and the second primary color data 622 and the third primary color data 623 may be written to the second sub-pixel SP2 and the third sub-pixel SP3 of the display unit U3, respectively, in accordance with for example the rule illustrated in FIG. 6. In addition, in the third embodiment, two rows of the pixel data 62 are dealt with as a unit by the rule of the display signal generating process. That is, different selection rules are adopted for the first and the second rows of the pixel data 62, and the selection rules adopted for the third and the fourth rows of the pixel data 62 are the same as those for the first and the second rows of the pixel data 62, respectively, and so on.

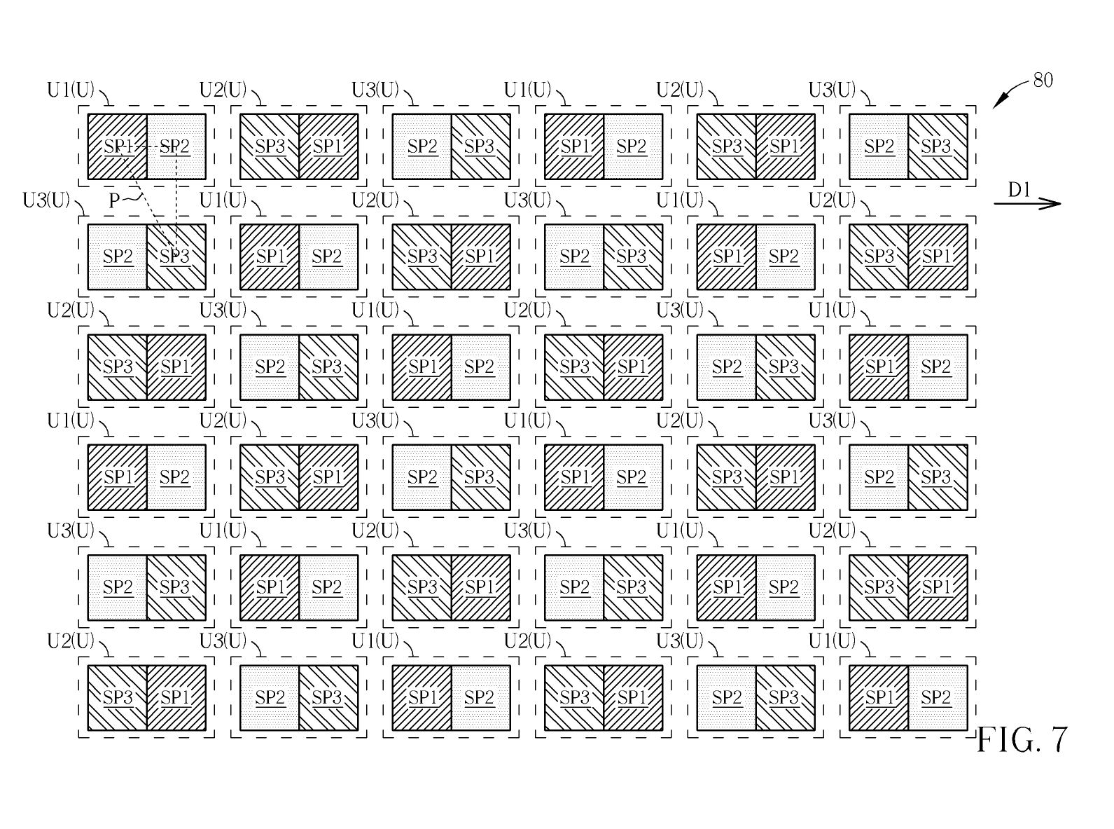

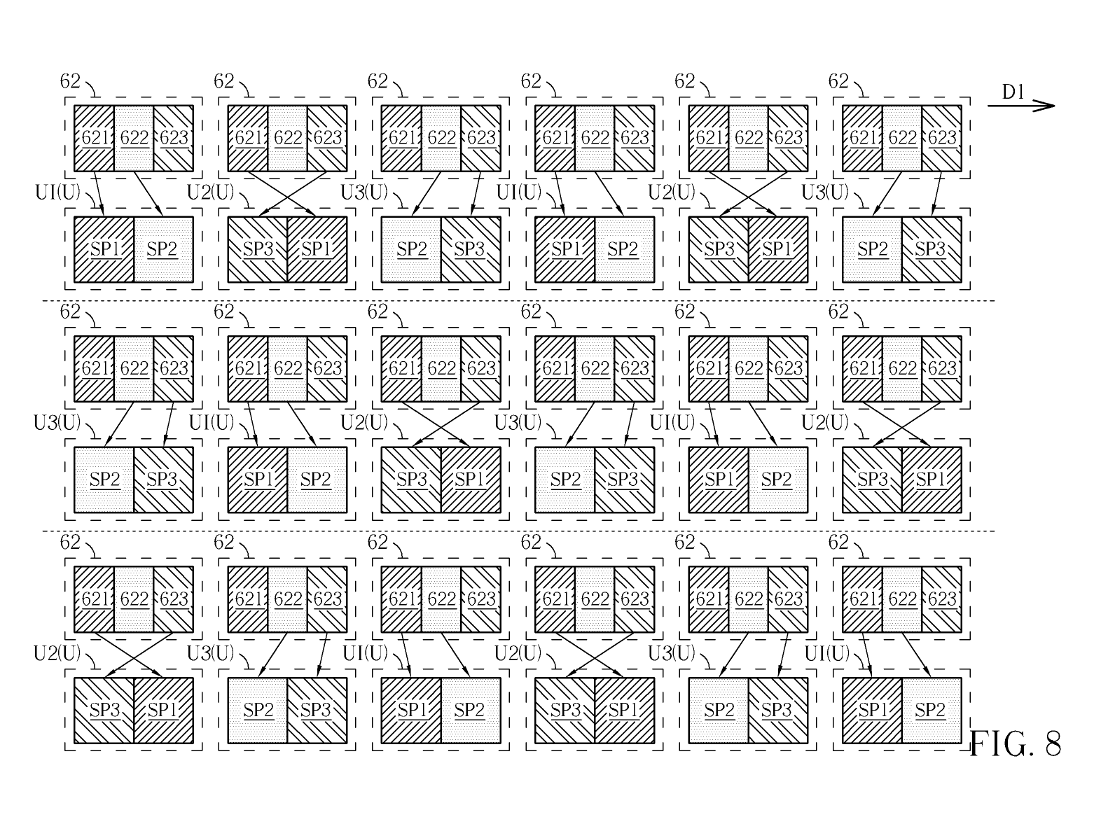

Please refer to FIG. 7 and FIG. 8 with FIG. 2 together. FIG. 7 and FIG. 8 are schematic diagrams illustrating an image processing method of a flat display panel according to the fourth preferred embodiment of the present invention. The rules for image processing methods in the fourth and the third embodiments are similar. The difference is that three rows of the pixel data 62 are dealt with as a unit by the rule of the display signal generating process in the fourth embodiment. That is, different selection rules are adopted for the first, the second and the third rows of the pixel data 62, and the selection rules adopted for the fourth, the fifth and the sixth rows of the pixel data 62 are the same as those for the first, the second and the third rows of the pixel data 62, respectively, and so on.

In summary, the image processing method is carried out with the concept of pixel sharing or sampling, in which, one of the three primary color data contained in an original pixel data is given up; while, under the pixel arrangement for the pixel array in the present invention, an image signal of relatively high resolution may be rendered to a pixel array of relatively low resolution and the color mixing problems are effectively resolved without affecting the color of the display image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method of a flat display panel, comprising:
providing a pixel array comprising a plurality of display units each comprising two sub-pixels;
providing an image-signal-to-be-processed comprising a plurality of pixel data each comprising three primary color data, which are different; and
performing a display signal generating process to write two of the primary color data selected from at least one of the pixel data of the image-signal-to-be-processed to the two sub-pixels of one of the display units of the pixel array.

2. The image processing method of the flat display panel according to claim 1, wherein, the display units has a number of X*Y, the pixel data has a number of N*M, and X*Y is less than N*M.

3. The image processing method of the flat display panel according to claim 2, wherein X*Y is equal to 2(N*M)/3.

4. The image processing method of the flat display panel according to claim 1, wherein, the display signal generating process comprises:
writing a first one of the primary color data of one of the pixel data of the image-signal-to-be-processed to one of the two sub-pixels; and
writing a second one of the primary color data to the other of the two sub-pixels, wherein the second one of the primary color data is the minimum of a third one of the primary color data from the one of the pixel data and a fourth one of the primary color data from another one of the pixel data of the image-signal-to-be-processed, and the third one and the fourth one of the primary color data both are of a same primary color.

5. The image processing method of a flat display panel according to claim 1, wherein, the display signal generating process comprises:
writing a first one of the primary color data selected from one of the pixel data of the image-signal-to-be-processed to one of the two sub-pixels; and
writing a second one of the primary color data to the other of the sub-pixels, wherein the second primary color data is a mean value of a third one of the primary color data from the one of the pixel data and a fourth one of the primary color data from another one of the pixel data of the image-signal-to-be-processed, and the third one and the fourth one of the primary color data both are of a same primary color.

6. The image processing method of a flat display panel according to claim 1, wherein the display signal generating process comprises writing the two of the primary color data from a same one of the pixel data of the image-signal-to-be-processed to the two sub-pixels, respectively.

7. The image processing method of a flat display panel according to claim 1, wherein each of the display units consists of two sub-pixels .

8. A pixel array of a flat display panel, comprising:
a plurality of display units arranged in an array and each of the display units comprising two sub-pixels, wherein any three adjacent sub-pixels in a row of the array are for displaying three different primary colors, respectively.

9. The pixel array of a flat display panel according to claim 8, wherein each of the display units consists of two sub-pixels.

10. The pixel array of a flat display panel according to claim 8, wherein, the display units comprise a plurality of first display units, a plurality of second display units, and a plurality of third display units; one of the two sub-pixels of one of the first display units and one of the two sub-pixels of one of the second display units are for displaying a same first primary color; one of the two sub-pixels of one of the first display units and one of the two sub-pixels of one of the third display units are for displaying a same second primary color; and one of the two sub-pixels of one of the second display units and one of the two sub-pixels of one of the third display units are for displaying a same third primary color.
